(19) United States
(12) Patent Application Publication
(10) Pub. No.: US 2026/0355942 A1
(43) Pub. Date: Nov. 12, 2026

(54) ROBOT CONTROL DEVICE AND PROGRAM

(71) Applicant: FANUC CORPORATION, Minamitsuru-gun, Yamanashi (JP)

(72) Inventor: Keisuke NAGANO, Minamitsuru-Gun, Yamanashi (JP)

(73) Assignee: FANUC CORPORATION, Minamitsuru-gun, Yamanashi (JP)

(21) Appl. No.: 19/515,842

(22) PCT Filed: Sep. 27, 2023
(86) PCT No.: PCT/JP2023/035218

§ 371 Date: Mar. 3, 2026

(51) Int. Cl. B25J 9/16

(52) U.S. Cl. CPC B25J 9/161; B25J 9/1664

(57) ABSTRACT

A robot control device (10) comprises: a drive device (18) that is detachable and can read a writable storage medium (19); and a control unit (12) that controls a robot device on the basis of a control program stored in a storage unit (14) provided separately from the drive device. In a state in which the storage medium is mounted on the drive device, the control unit: reads data stored in the storage medium at the time of startup; on the basis of server information included in the data, connects via a network to a server device (40) on which a control program is stored; reads first robot identification information that is included in the control program; compares the first robot identification information and second robot identification information that is for identifying the robot device stored in the storage unit; when the first robot identification information and the second robot identification information match the robot device, acquires the control program from the server device and stores the acquired control program in the storage unit; and controls the robot device (20) on the basis of the control program.

### TECHNICAL FIELD

The present disclosure relates to a robot controller and a program capable of updating a control program.

### BACKGROUND ART

A robot device can be adapted to different work applications by changing a control program stored in stored in a robot controller. Generally, the control program to be initially activated is stored in a ROM provided in the robot controller. At startup, the robot controller reads the program stored in the ROM and executes a startup program, by activating a boot loader. In recent years, as file sizes of such programs have been increasing, the programs are stored in a storage unit externally connected to the robot controller (e.g., see Patent Literature 1).

Patent Literature 1 describes a robot controller with a network function. This robot controller is configured such that when a boot loader is activated at startup, the robot controller reads out a program to be activated at boot time from an externally connected storage unit based on a program location table including information relating to multiple locations, and stores the program in its own memory and activate the program.

### CITATION LIST

### Patent Literature

[PTL 1] JP 2007-141205 A

### SUMMARY OF INVENTION

### Technical Problem

The robot controller described in Patent Literature 1 is required to input program information stored in the externally connected storage unit when loading a program based on execution of a boot loader. According to the robot controller described in Patent Literature 1, when the program is updated, the information must be input to the robot controller in order to update the program information stored in the externally connected storage unit. Generally, the robot controller is connected to a teach pendant, through which operations for operating the robot device are input. The teach pendant is configured to be optimized for inputting the operations for the robot device. The robot controller described in Patent Literature 1 has a problem in that it is time-consuming to input the information from the externally connected storage unit and load the program based on the operation on the teach pendant.

An object of the present invention is to provide a robot controller and a program that allow easy loading of a control program.

### Solution to Problem

One aspect of the present disclosure is a robot controller comprising: a drive device capable of reading a removable and rewritable storage medium; and a control unit configured to control a robot device based on a control program stored in a storage unit provided separately from the drive device, wherein, when the storage medium is mounted on the drive device, the control unit is configured to: read out data stored in the storage medium at a time of startup; based on server information included in the data, connect via a network to a server device in which the control program is stored; read out first robot identification information included in the control program; compare the first robot identification information to second robot identification information for identifying the robot device stored in the storage unit; when the first robot identification information and the second robot identification information match the robot device, obtain the control program from the server device and store the obtained control program in the storage unit; and control the robot device based on the control program.

### BRIEF DESCRIPTION OF DRAWINGS

FIG. 1 is a block diagram showing a configuration of a robot controller according to an embodiment.

FIG. 2 is a flowchart showing a process flow of a method for obtaining a control program executed in the robot controller.

### DESCRIPTION OF EMBODIMENTS

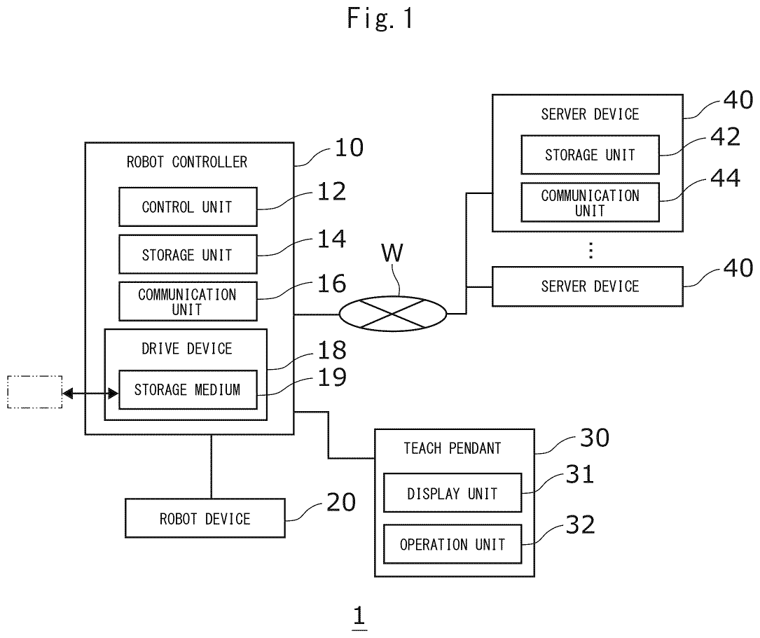

As shown in FIG. 1, a robot system 1 is constituted by a robot device 20 configured to perform a specified task, a robot controller 10 configured to control the robot device 20, a teach pendant 30 communicatively connected to the robot controller 10, and a server device 40 communicatively connected to the robot controller 10.

The robot device 20 is, for example, a work robot having an articulated robot arm. The robot device 20 is controlled by the robot controller 10 based on a content of an operation of the teach pendant 30 operated by a user. The robot arm constituting the robot device 20 includes a plurality of hardware units for realizing a predetermined motion. The robot arm has a plurality of drive units for driving a plurality of joints. Each drive unit is, for example, configured by a servomotor. Each drive unit is configured to adjust a rotation angle of each joint to operate the robot arm.

Each drive unit of the robot arm is operated based on a control signal transmitted by the robot controller 10. Each drive unit is provided with an amplifier configured to adjust the drive power of the servomotor. The drive unit is provided with various sensors, such as a force sensor configured to detect a force and a pulse coder configured to detect the position and/or speed. The various sensors transmit output values to the robot controller 10. The robot controller 10 operates the robot arm based on the output values of the various sensors. The robot device 20 may be constituted by other devices as well as a robot arm. The configuration of the robot device 20 maybe conventional, and a detailed explanation thereof will be omitted.

The teach pendant 30 is connected to the robot controller 10 by wire or wirelessly. The teach pendant 30 has a display unit 31 capable of displaying information. The display unit 31 is configured with a liquid crystal display, or an organic EL (Electro Luminescence) display, etc. The teach pendant 30 has an operation unit 32 configured to accept user operations. The operation unit 32 is configured with a user interface such as a keyboard and/or buttons. The operation unit 32 may be integrated into the touch-panel display unit 31 which can be operated by touch.

The teach pendant 30 is configured to transmit an operation signal corresponding to a user's operation to the robot controller 10. Upon receiving the operation signal, the robot controller 10 transmits a control signal corresponding to the operation signal to the robot device 20, causing the robot device 20 to perform a motion corresponding to the operation content. The server device 40 is communicably connected to the robot controller 10 via a network W. The server device 40 includes a storage unit 42 configured to store, for example, data and a program. The storage unit 42 stores, for example, a control program for controlling the robot device 20 and management data for managing the control program, as described below.

The management data is, for example, a database in which a table for managing hardware units constituting the robot device 20 is recorded. The control program is updated by the user. The updated control program is stored in the storage unit 42. The management data is also updated in accordance with the updated control program. The updated management data is stored in the storage unit 42. The server device 40 is provided with a communication unit 44 which can be connected to the network W. The communication unit 44 is, for example, a communication interface which can be connected to the network W via a wired connection such as Ethernet (registered trademark). The communication unit 44 may also be a communication interface which can be connected to the network W wirelessly. One or more server devices 40 may be provided via the network W.

The robot controller 10 is constituted by a computer device capable of controlling the robot device 20. The robot controller 10 has a communication unit 16 connectable to a network W. The communication unit 16 is a communication interface connectable to the network W via a wired connection such as Ethernet (registered trademark). The communication unit 16 may also be a communication interface connectable to the network W wirelessly. The robot controller 10 is connected to the network W via the communication unit 16 and communicates with the server device 40.

The robot controller 10 includes a control unit 12 configured to control the robot device 20 and execute various arithmetic processing. The control unit 12 is constituted by a processor such as a CPU (Central Processing Unit). The control unit 12 executes various processes for controlling the robot device 20 based on a control program described below. The robot controller 10 is provided with a ROM (Read Only Memory) which stores a boot loader configured to be executed at startup as a peripheral device of the control unit 12, and a RAM (Random Access Memory) which is used as a work area required for processing. The boot loader is a program which is activated when the robot controller 10 is powered on.

The robot controller 10 includes a drive device 18 capable of reading a storage medium 19. The storage medium 19 is configured as a removable, rewritable storage medium, such as a USB (Universal Serial Bus) memory or a memory disk. The drive device 18 includes a USB slot and a card slot, etc. The drive device 18 is configured to read the storage medium 19. When the storage medium 19 is installed, the drive device 18 outputs a recognition signal indicating that the storage medium 19 is installed to the control unit 12. The storage medium 19 stores data for communication connection to a server device 40, for example. The data includes server information required for communicable connection to the server device 40 via a network W.

The server information includes, for example, a MAC address and an IP address of the server device 40, a file name of the control program, and a management file name included in the management data for managing the control program. The user can write data to the storage medium 19 using an information processing terminal device other than the robot device 20, such as a personal computer. Therefore, the user does not need to write data to the storage medium 19 using the teach pendant 30, which is difficult to use for inputting information. Before activating the robot controller 10, the user can insert the storage medium 19 having written data into the drive device 18 and make the storage medium 19 readable. When the updated control program is stored in the server device 40, the user removes the storage medium 19 from the drive device 18 and updates the data in the storage medium 19 using the information processing terminal device.

When the boot loader is activated, the control unit 12 recognizes the storage medium 19 based on the recognition signal output from the drive device 18, reads out server information from the storage medium 19, obtains the control program for controlling the robot device 20 from the server device 40, and stores the program in the storage unit 14. The robot controller 10 includes a storage unit 14 provided separately from the drive device 18. The storage unit 14 is built into the robot controller 10. The storage unit 14 may also be configured as an external storage externally connected to the robot controller 10. The storage unit 14 is constituted by a non-transitory storage medium such as a hard disk drive (HDD) or a flash memory which stores data and programs necessary for control. The storage unit 14 stores data and programs necessary for control executed by the control unit 12. The storage unit 14 pre-stores multiple programs, such as a startup program for an OS (Operating System). The storage unit 14 stores the control program obtained from the server device 40.

Hereinafter, the processing executed by the control unit will be described. The user writes data including the server information to the storage medium 19, and installs it in the drive device 18. With the storage medium 19 installed in the drive device 18, the user turns on the power to the robot controller 10 and activates the robot controller 10. At startup, the boot loader stored in the ROM is activated. The control unit 12 reads out a startup program from the storage unit 14 and executes the startup program based on the activation of the boot loader.

When the startup program is executed, the control unit 12 recognizes the storage medium 19 based on the recognition signal output from the drive device 18, and reads out the data stored in the storage medium 19. The control unit 12 connects to the server device 40 via the network W based on the server information included in the data. The control unit 12 searches for the control program stored in the memory unit 42 based on the file name of the control program and management data for managing the control program included in the server information. The control unit 12 extracts the control program and reads out first robot identification information included in the control program. The first robot identification information may be recorded in the control program or may be recorded in the management data generated in association with the control program.

The control unit 12 may read out the first robot identification information included in the management data generated in association with the control program. The management data may include information associating the first robot identification information with the file name of the control program. The control unit 12 may extract the file name of the control program based on the first robot identification information included in the management data. The first robot identification information includes format information and version information of each hardware unit. The format information of each hardware unit includes information on the formats of various sensors, such as a plurality of servomotors, an amplifier, a force sensor, and a pulse coder, which constitute the drive unit. The version information of each hardware unit includes information on the versions of various sensors, such as the plurality of servomotors, the amplifier, the force sensor, and the pulse coder, which constitute the drive unit.

The control unit 12 reads out second robot identification information stored in the storage unit 14. The second robot identification information is a database stored in advance in the storage unit 14 by the user. Similarly to the first robot identification information, the second robot identification information includes format information and version information for each hardware unit. The control unit 12 compares the first robot identification information read out from the server device 40 with the second robot identification information. When the contents of the first robot identification information and the second robot identification information match and are compatible with the robot device 20, the control unit 12 obtains the control program from the server device 40 and stores it in the storage unit 14.

For example, when the format information and the version information of each hardware unit included in the first robot identification information match the format information and the version information included in the second robot identification information, respectively, the control unit 12 obtains the control program from the server device. The control unit 12 may output a matching result, indicating that the first robot identification information and the second robot identification information match, to the display unit 31 of the teach pendant 30. The control unit 12 may output the contents of the first robot identification information and the second robot identification information to the display unit 31. The control unit 12 controls the robot device 20 based on the control program stored in the storage unit 14.

When the content of the first robot identification information and the content of the second robot identification information do not match, the control unit 12 may output a matching result, indicating that matching is not possible, to the display unit 31 of the teach pendant 30. When the matching is not possible, the control unit 12 may output an operation method to be performed by the user to the display unit 31. At this time, the control unit 12 may output, for example, display a content to the display unit 31 which prompts the user to perform an operation to search for a different server device 40. At this time, the control unit 12 may output information which corresponds to the difference between the content of the first robot identification information and the second robot identification information to the display unit 31.

The control program is updated by the user as appropriate. The updated control program is stored in the server device 40. The first robot identification information is updated in accordance with the updated control program. The user updates the data stored in the storage medium 19 in accordance with the updated control program. The user updates the server information included in the data stored in the storage medium 19. The user installs the storage medium 19, in which the updated data is stored, into the drive device 18.

At startup, the control unit 12 connects to the server device 40 via the network W based on the updated server information included in the updated data. The control unit 12 connects to the server device 40 based on the updated data, and compares the first robot identification information updated in accordance with the control program with the second robot identification information stored in the storage unit 14. The control unit 12 compares the updated first robot identification information with the second robot identification information. When the content of the updated first robot identification information and the content of the second robot identification information match and are compatible with the robot device 20, the control unit 12 obtains the updated control program from the server device 40 and stores it in the storage unit 14.

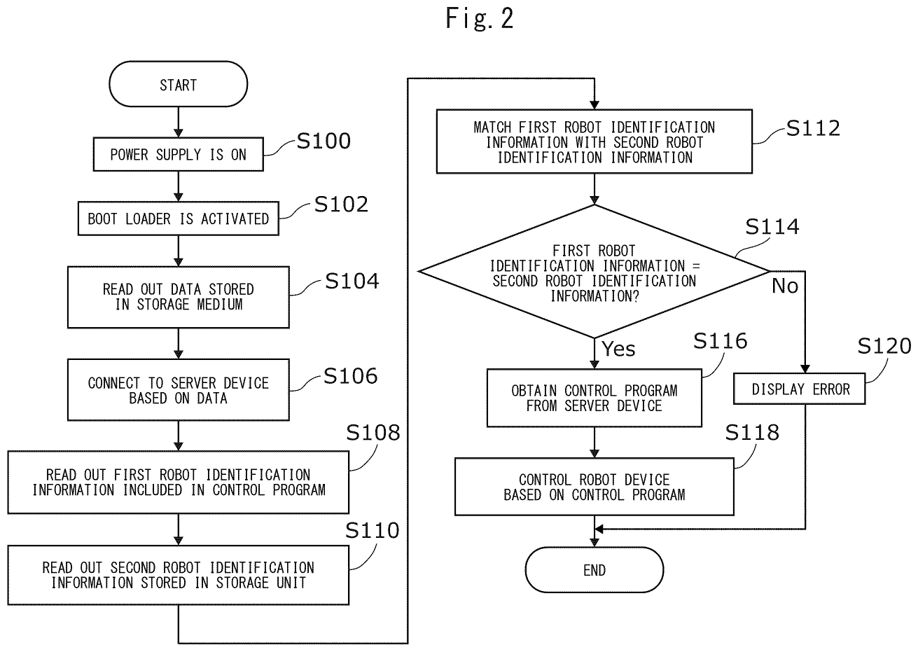

FIG. 2 shows the process executed by the robot controller 10. A program installed on a computer implemented in the robot controller 10 causes the robot controller 10 to execute the following process: The robot controller 10 is powered on (step S100). The boot loader stored in the ROM is activated (step S102). The control unit 12 recognizes the storage medium 19 implemented in the drive device 18 based on the recognition signal, and reads out the data stored in the storage medium 19 (step S104). The control unit 12 connects via the network to the server device 40 which stores the control program for controlling the robot device 20 based on the server information included in the data (step S106). The control unit 12 reads out the first robot identification information included in the control program (step S108).

The control unit 12 reads out the first robot identification information and the second robot identification information for identifying the robot device stored in the storage unit 14 (step S110). The control unit 12 compares the first robot identification information with the second robot identification information (step S112). The control unit 12 determines whether the first robot identification information and the second robot identification information match the robot device (step S114). When the first robot identification information and the second robot identification information match the robot device, the control unit 12 obtains the control program from the server device and stores it in the memory unit (step S116). The control unit 12 controls the robot device 20 based on the control program (step S118).

When the first robot identification information and the second robot identification information do not match the robot device, the control unit 12 causes the display unit 31 of the teach pendant 30 to display an error message (step S120).

As described above, the robot controller 10 allows easy loading of the control program. The robot controller 10 allows the user to easily write the server information to the storage medium 19 removed from the drive device 18 using an information processing terminal device other than the teach pendant 30. Due to the robot controller 10, the control program compatible with the robot device 20 can be assuredly obtained, by comparing the first robot identification information with the second robot identification information when the robot controller 10 connects to the server device 40. Due to the robot controller 10, the updated control program compatible with the robot device 20 can be assuredly obtained, by updating the server information in the storage medium 19 when the control program of the server device 40 is updated. The robot control device 10 allows easy updating of a large-capacity control program.

The control unit 12 is, for example, a functional module implemented by a computer program executed on a processor. The computer program for executing the process of each unit of the control unit 12 may be provided in a form recorded on a computer-readable recording medium such as a semiconductor memory, a magnetic recording medium, or an optical recording medium.

Although the present disclosure has been described in detail, the present disclosure is not limited to the above-mentioned individual embodiments. Various additions, replacements, modifications, partial deletions, etc. are possible for these embodiments within the scope of the gist of the present disclosure, or within the scope of the gist of the present disclosure derived from the contents described in the claims and their equivalents. These embodiments can also be implemented in combination. For example, in the above-mentioned embodiments, the order of each operation and the order of each process are shown as examples, and are not limited to these. The same applies when numerical values or formulas are used in the description of the above-mentioned embodiments.

The following supplementary clauses are further disclosed regarding the above-described embodiment and modified examples.

### (Clause 1)

A robot controller comprising: a drive device capable of reading a removable and rewritable storage medium; and a control unit configured to control a robot device based on a control program stored in a storage unit provided separately from the drive device, wherein, when the storage medium is mounted on the drive device, the control unit is configured to: read out data stored in the storage medium at a time of startup; based on server information included in the data, connect via a network to a server device in which the control program is stored; read out first robot identification information included in the control program; compare the first robot identification information to second robot identification information for identifying the robot device stored in the storage unit; when the first robot identification information and the second robot identification information match the robot device, obtain the control program from the server device and store the obtained control program in the storage unit; and control the robot device based on the control program.

### (Clause 2)

The robot controller according to clause 1, wherein the robot device has a plurality of hardware units for realizing a predetermined motion, and
wherein the control unit obtains the control program from the server device when format information and version information of each hardware unit included in the first robot identification information match format information and version information included in the second robot identification information, respectively.

### (Clause 3)

The robot controller according to clause 1, wherein, when the control program is updated and stored in the server device and when the data which is updated corresponding to the control program is stored in the storage medium, the control unit connects to the server device via a network based on the server information which is updated and included in the updated data.

### (Clause 4)

The robot controller according to clause 3, wherein the control unit is configured to: connect to the server device based on the updated data; compare the first robot identification information updated corresponding to the control program to the second robot identification information; and obtain the updated control program.

### (Clause 5)

A program installed on a computer implemented in a robot controller 10 configured to control a robot device, wherein the program is configured to: recognize a removable and rewritable storage medium based on a recognition signal indicating a state in which the storage medium is installed in a drive device; read out data stored in the storage medium at a time of startup; based on server information included in the data, connect the robot controller via a network to a server device in which a control program for controlling the robot controller is stored; read out first robot identification information included in the control program; compare the first robot identification information to second robot identification information for identifying the robot device stored in a storage unit provided separately from the drive device; and when the first robot identification information and the second robot identification information match the robot device, obtain the control program from the server device and store the obtained control program in the storage unit.

### REFERENCE SIGNS LIST

1 robot system
10 robot controller
12 control unit
14 storage unit
16 communication unit
18 drive device
19 storage medium
20 robot device
30 teach pendant
40 server device

1. A robot controller comprising:
a drive device capable of reading a removable and rewritable storage medium; and
a control unit configured to control a robot device based on a control program stored in a storage unit provided separately from the drive device,
wherein, when the storage medium is mounted on the drive device, the control unit is configured to:
read out data stored in the storage medium at a time of startup;
based on server information included in the data, connect via a network to a server device in which the control program is stored;
read out first robot identification information included in the control program;
compare the first robot identification information to second robot identification information for identifying the robot device stored in the storage unit;
when the first robot identification information and the second robot identification information match the robot device, obtain the control program from the server device and store the obtained control program in the storage unit; and
control the robot device based on the control program.

2. The robot controller according to claim 1, wherein the robot device has a plurality of hardware units for realizing a predetermined motion, and
wherein the control unit obtains the control program from the server device when format information and version information of each hardware unit included in the first robot identification information match format information and version information included in the second robot identification information, respectively.

3. The robot controller according to claim 1, wherein, when the control program is updated and stored in the server device and when the data which is updated corresponding to the control program is stored in the storage medium, the control unit connects to the server device via a network based on the server information which is updated and included in the updated data.

4. The robot controller according to claim 3, wherein the control unit is configured to:
connect to the server device based on the updated data;
compare the first robot identification information updated corresponding to the control program to the second robot identification information; and
obtain the updated control program.

5. A computer-readable recording medium recording a program, installed on a computer implemented in a robot controller configured to control a robot device, wherein the program is configured to:
recognize a removable and rewritable storage medium based on a recognition signal indicating a state in which the storage medium is installed in a drive device;
read out data stored in the storage medium at a time of startup;
based on server information included in the data, connect the robot controller via a network to a server device in which a control program for controlling the robot controller is stored;
read out first robot identification information included in the control program;
compare the first robot identification information to second robot identification information for identifying the robot device stored in a storage unit provided separately from the drive device; and
when the first robot identification information and the second robot identification information match the robot device, obtain the control program from the server device and store the obtained control program in the storage unit.
